(19) United States
(12) Patent Application Publication
(10) Pub. No.: US 2013/0344731 A1
(43) Pub. Date: Dec. 26, 2013

(54) POWERED UTILITY RAIL

(71) Applicant: OFS Brands Inc., Huntingburg, IN (US)

(72) Inventors: Douglas D. Shapiro, Jasper, IN (US); Michael S. Wagner, Jasper, IN (US); Bradley M. DeBruyne, Grand Rapids, MI (US); Gary W. Petertyl, Rockford, MI (US); Adam P. Meeuwsen, Grandville, MI (US)

(21) Appl. No.: 13/922,574

(22) Filed: Jun. 20, 2013

Related U.S. Application Data
(60) Provisional application No. 61/662,508, filed on Jun. 21, 2012.

(51) Int. Cl. H01R 13/60; F16M 13/02

(52) U.S. Cl. CPC H01R 13/60; F16M 13/02
USPC 439/532; 248/314

(57) ABSTRACT

The present invention generally relates to a powered utility rail, and, in particular, a powered utility rail for installation on furniture to provide electrical connectivity for portable electronic devices.

### CROSS REFERENCE TO RELATED APPLICATION

This application claims the benefit of priority to U.S. Provisional Patent Application Ser. No. 61/662,508, filed Jun. 21, 2012, for SIDE RAIL, incorporated herein by reference.

### BACKGROUND OF THE INVENTION

(a) Field of the Invention

The present invention generally relates to a powered utility rail, and, in particular, a powered utility rail for installation on furniture to provide electrical connectivity for portable electronic devices.

(b) Description of the Prior Art

Electronic devices are a part of daily life. Cell phones, tablet computers, laptop computers, digital music players, and other devices are prevalent in residential, commercial, and industrial settings. Users face a periodic need to recharge their electronic devices to ensure that they remain in working order.

It is common during business meetings and presentations for individuals to be seated around a conference table. Several individuals may simultaneously be using electronic devices for note taking, transferring data, providing visual or audio information, or other purposes. Tables with integrated electrical connectivity generally have power outlets positioned on their upper surfaces. In this arrangement, power and data cords stretch across the upper surface of the table, which provides an unsightly distraction and occupies valuable table space.

### SUMMARY OF THE INVENTION

The present disclosure relates to a powered utility rail providing electrical connectivity for portable electronic devices. The powered utility rail is mounted beneath a supporting surface, such as the lower surface of a table top. This allows existing tables to be retrofitted to include electrical connectivity without defacing the upper surface of the table.

One aspect of the present invention pertains to a bracket for coupling a f2f USB adapter to a flat surface, the bracket comprising a hollow body defining a cavity sized to receive a standard f2f USB adapter having opposing ends, wherein the body includes an aperture allowing an inserted end of the f2f adapter to extend through the bracket, wherein the bracket includes a pair of opposing extensions extending substantially perpendicular to the body, each extension having a bore oriented substantially parallel to the body.

Another aspect of the present invention pertains to a powered utility rail comprising at least one side rail, the side rail including at least one power outlet and a fastener configured to secure the side rail beneath a supporting surface, and a power conduit in electrical connection with the at least one power outlet.

In some embodiments of this aspect, the at least one side rail is at least one elongated side rail extending parallel to the supporting surface. In further embodiments, the supporting surface is a table top. In certain embodiments, the supporting surface includes an opposing upper surface and at least one side connecting the upper surface and supporting surface. In some embodiments, the at least one side rail is spaced inwards from the at least one side and wherein the at least one side rail extends substantially parallel to the at least one side. In further embodiments, the supporting surface overhangs the at least one side rail.

In some embodiments, the powered utility rail includes a plurality of side rails, each side rail including at least one power outlet and a fastener configured to secure the side rail beneath a supporting surface. The embodiments may also include a connector rail configured to couple two side rails. In certain embodiments, the powered utility rail comprises four side rails and four connector rails forming a quadrilateral shape, wherein the side rails forming the sides of the quadrilateral shape and the connector rails forming the vertices of the quadrilateral shape. In various embodiments, the quadrilateral shape is a square or a rectangle. In other embodiments, the at least one side rail is formed in the shape of one of a circle and an oval.

In some embodiments, the power conduit is in electrical connection with an external power source. In further embodiments, the at least one side rail includes at least one of a 110 volt power outlet, a 220 volt power outlet, a USB port, a micro-USB port, a serial computing port, a parallel computing port, a HDMI port, a FireWire port, an Ethernet port, a coaxial connector, a S-video connector, a VGA connector, and a DVI connector. In certain embodiments, the at least one power outlet includes at least one of a USB port and a micro USB power outlet.

In some embodiments, the powered utility rail further comprises a power adapter in electrical connection with the power conduit, and at least one low voltage power line in electrical connection with the power adapter and at least one of the at least one power outlet. In further embodiments, the at least one side rail includes at least one video connector. In certain embodiments, the powered utility rail further comprises a video hub in communication with the at least one video connector via a data line.

In some embodiments, the at least one side rail includes at least one data connector. In further embodiments, the powered utility rail further comprises a data hub in communication with the at least one data connector via a data line.

### BRIEF DESCRIPTION OF THE DRAWINGS

A better understanding of the present invention will be had upon reference to the following description in conjunction with the accompanying drawings, wherein:

FIG. 1A is a bottom view of a first embodiment of a powered utility rail installed on a table.

FIG. 1B is a bottom perspective view of the first embodiment of a powered utility rail installed on a table.

FIGS. 2A-D depict various views of the first embodiment of a powered utility rail with electrical components omitted for clarity. FIG. 2A is a top view. FIG. 2B is a top perspective view. FIG. 2C is a first side view. FIG. 2D is a second side view.

FIGS. 3A-D depict various views of a second embodiment of a powered utility rail with electrical components omitted for clarity. FIG. 3A is a top view. FIG. 3B is a top perspective view. FIG. 3C is a first side view. FIG. 3D is a second side view.

FIG. 4 is a top perspective view of the first embodiment of a powered utility rail.

FIG. 5 is a diagram of a table incorporating a powered utility rail.

FIG. 6 is a diagram of a table incorporating a powered utility rail, showing the power conduit.

FIG. 7 is a diagram of a bottom view of the table incorporating a side rail, showing low voltage power lines.

FIG. 8 is a diagram of a bottom view of the table incorporating a side rail, showing data lines.

FIGS. 9A-D depict various views of a bracket. FIG. 9A is a perspective view of the bracket. FIG. 9B is a top view of the bracket. FIG. 9C is a sectional view of the bracket along lines B-B of FIG. 9B. FIG. 9D is a sectional view of the bracket along lines A-A of FIG. 9B.

### DETAILED DESCRIPTION OF THE PREFERRED EMBODIMENT

For the purpose of promoting an understanding of the principles of the invention, reference will now be made to certain embodiments illustrated in the disclosure and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. In particular, while certain aspects and features are described in connection with a powered utility rail mounted on the underside of a table, the present invention is not limited to use only with tables. Powered utility rails as disclosed herein have broad applicability and may be attached to many different objects apart from tables.

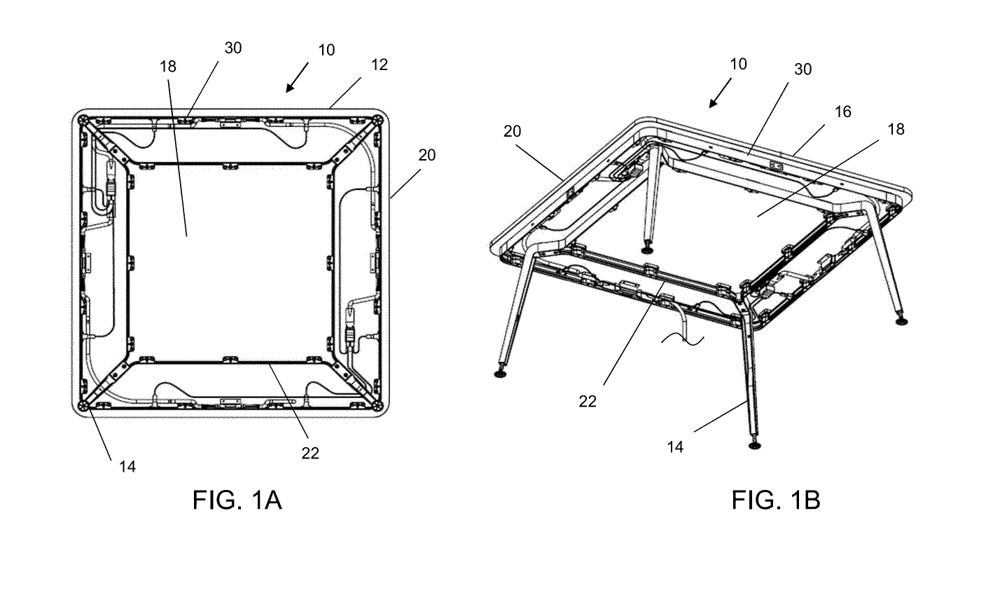

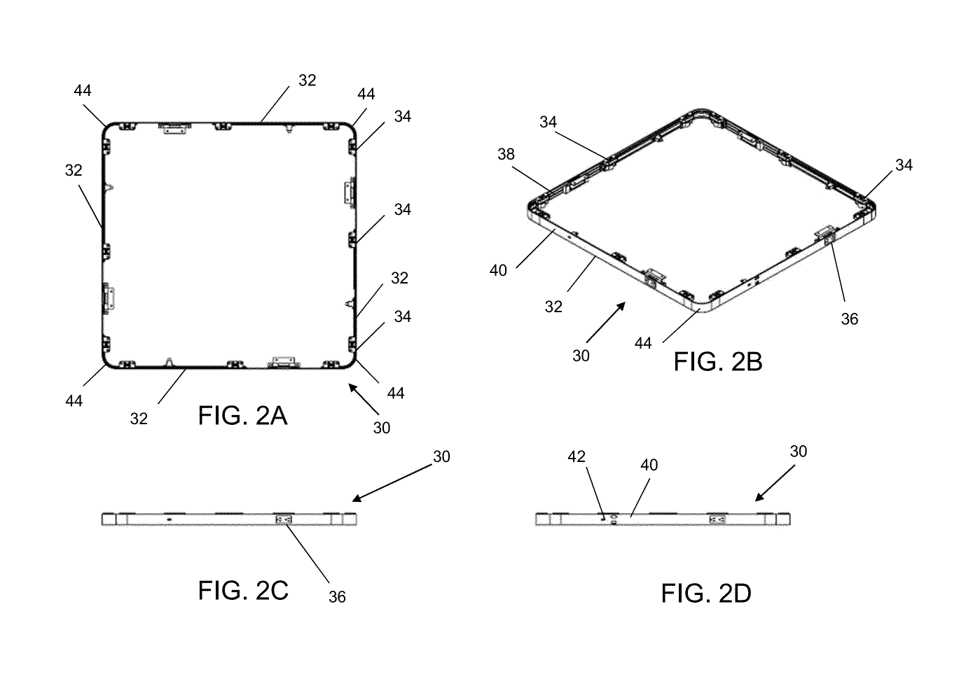

Referring now to FIGS. 1A and 1B, a table 10 has a table top 12 supported by at least one leg 14. The table top 12 includes an upper surface 16, an opposing supporting surface 18, namely, the lower surface of the table top 12. The table top also includes sides 20, shown here as perpendicular to the upper surface 16 and supporting surface 18. In the displayed embodiment, the table further includes a support frame 22 attached to the legs 14 and the supporting surface 18. The displayed table 10 is provided for example purposes only, and it should be understood that the powered utility rail disclosed herein may be installed on tables of other shapes and sizes, and with different numbers and placement of legs. The disclosed powered utility rail may also by installed on furniture apart from tables, such as, for example, podiums, workbenches, and desks.

A powered utility rail 30 is mounted beneath a supporting surface 18, in this case, the lower surface of the table top 12. In preferred embodiments, the utility rail 30 extends generally parallel to the sides 22 of the table top 12 and is positioned inwards from the sides 22 and outwards from the support frame 22, such that the table top 12 overhangs the utility rail 30. In preferred embodiment, the utility rail 30 is positioned sufficiently inwards from the sides 22 such that power plugs, USB ports, or other accessories attached to and extending from the utility rail 30 would not extend past the sides 22 of the table top 12. In these preferred embodiments, the table top 12 would provide a clean appearance when viewed from above, with the utility rail 30 and any attached plugs not being visible.

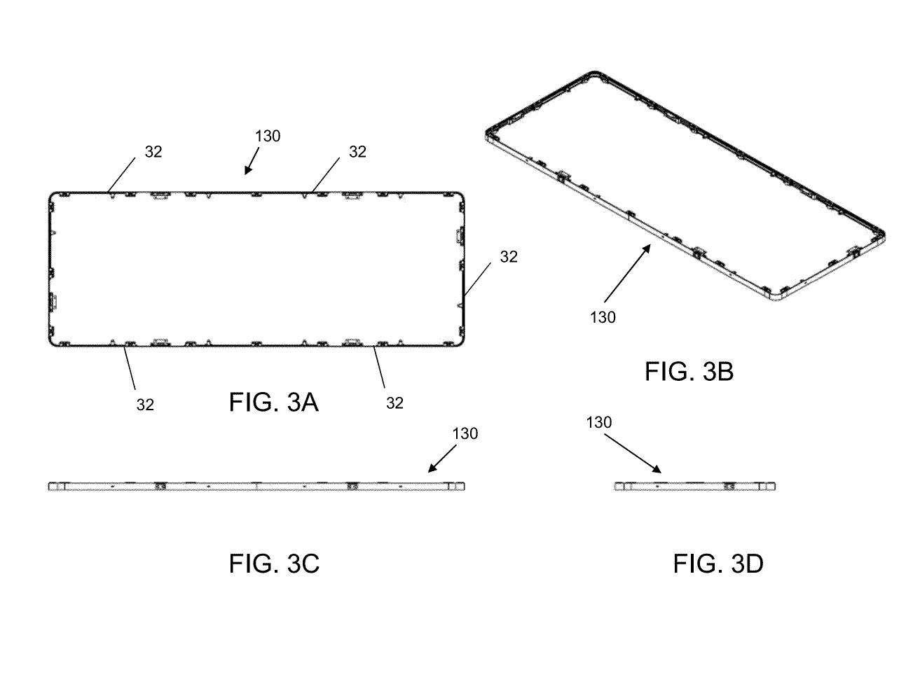

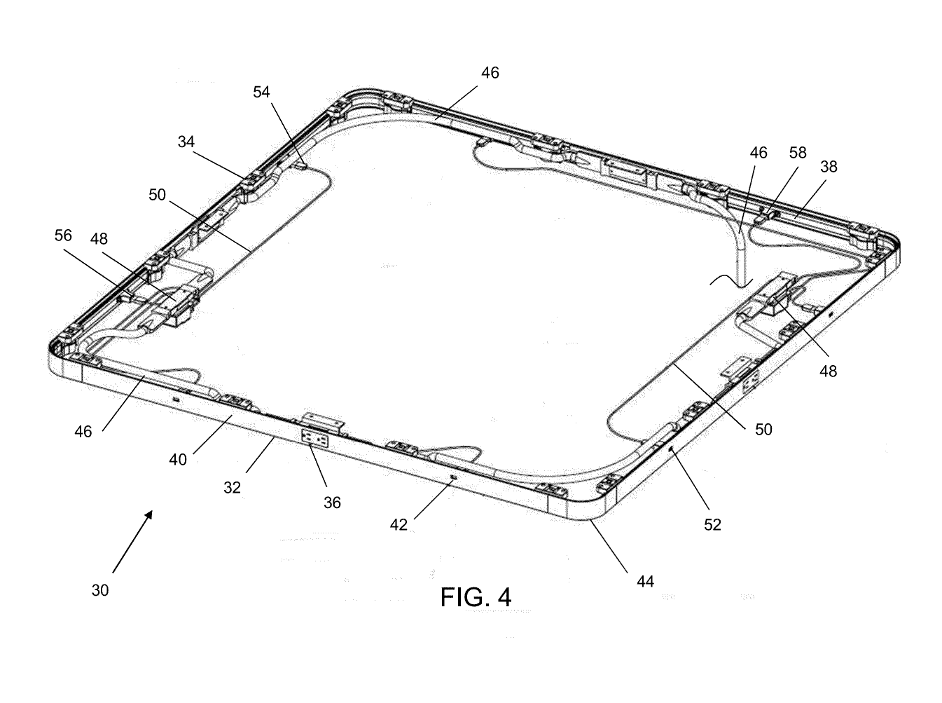

Referring now to FIGS. 2-4, the powered utility rail 30 includes at least one side rail 32, the side rail 32 including a fastener 34 to attach it to the supporting surface 18 and at least one power outlet 36 coupled to the side rail. In the depicted embodiment, the side rail 32 is a thin, elongated strip with an inner face 38 and an opposing outer face 40. The side rail includes cutouts 42 for each power outlet 36 coupled to the side rail 42. The at least one power outlet 36 is coupled to the inner face 40 of the side rail 32, the cutout 42 providing access to the power outlet 36 from the outer face 38 of the side rail 32. In some embodiments, as shown in FIGS. 2-4, each cutout 42 is sized to snugly fit the corresponding power outlet 42. As shown in FIGS. 2C and 2D, and 3C and 3D, it is not necessary that each individual side rail 32 include identical arrangements of cutouts and power outlets.

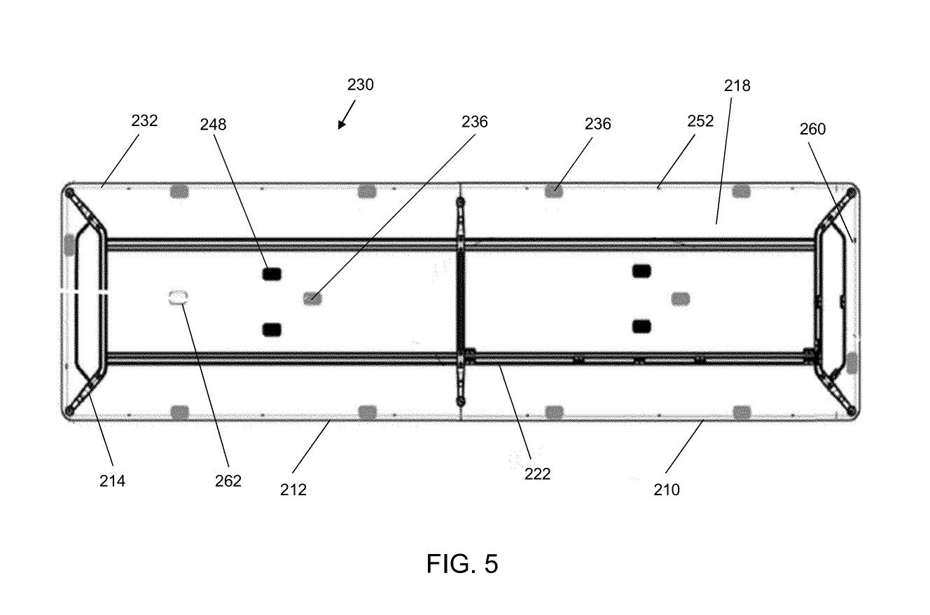

The powered utility rail 30 includes at least one side rail 32. In the first and second embodiments depicted in FIGS. 2-4, the powered utility rail includes four side rails, coupled by four connecting rails 44. The side rails 32 and connector rails 44 collectively form a quadrilateral shape, wherein the side rails 32 form the sides of the quadrilateral shape and the connector rails 44 forming the vertices of the quadrilateral shape. In the first embodiment shown in FIGS. 2 and 4, the quadrilateral shape is a square with rounded edges. In the second embodiment shown in FIG. 3, the quadrilateral shape is a rectangle with rounded edges. In this embodiment, the long sides of the rectangular powered utility rail 130 are formed by coupling two side rails 32 end to end. In other embodiments, the long sides of the rectangle may be formed by a single elongated side rail.

In these embodiments, the connector rails 44 are thin elongated strips shaped in 90 degree curves adapted to couple together nearby side rails 32, the side rails 32 oriented perpendicular to each other. In other embodiments, at least one side rail may form a circular, oval, or other geometric shape. In some embodiments, the at least one side rail will form a shape corresponding to the shape of the supporting surface, such as, for example, three straight side rails coupled by three 60 degree curved connecting rails forming a triangle for attachment to a triangular table or a single side rail curved in a circular shape for attachment to a circular table.

The powered utility rail 30 includes a power conduit 46 providing an electrical connection from an outside power source to each power outlet 36. In some embodiments, the power conduit 46 provides electricity to each power outlet 36 in series. In other embodiments, the power conduit 46 may include a plurality of power conduits. In such embodiments, electricity may be provided to each power outlet 36 in parallel, in series, or in a combination of parallel and series wiring configurations.

In some embodiments, the powered utility rail provides at least one of direct current (“DC”) power connectivity and alternating current (“AC”) electrical connectivity. In some embodiments, the powered utility rail provides video connectivity. In further embodiments, the powered utility rail provides data connectivity. In some embodiments, the side rail includes at least one of a 110 volt power outlet, a 220 volt power outlet, a USB port, a micro-USB port, a serial computing port, a parallel computing port, a HDMI port, a FireWire port, an Ethernet port, a coaxial connector, a S-video connector, a video graphics array (“VGA”) connector, and a digital visual interface (“DVI”) connector. In some embodiments, the power conduit terminates in a male power plug (not shown), which can be removably inserted into a wall power socket or other external power source. In other embodiments, the power conduit is fixed to an external power source. In some embodiments, the power conduit extends from the lower surface of the table top, down a table leg, and extends to an external power source.

In the embodiment depicted in FIG. 4, the powered utility rail 30 includes at least one power adapter 48. The power adapter 48 may be coupled to a side rail 32 or attached to the supporting surface. The power adapter 48 is in electrical communication with the power conduit 46, and is adapted to adjust the voltage received from the power conduit 46. In some embodiments, the at least one power adapter 46 is a USB power adapter configured to reduce voltage to a level suitable for USB use, typically 5V. At least one low voltage power line 50 provides electricity from the at least one power adapter 46 to each USB port 52 coupled to the side rail. In some embodiments, the low voltage power line 50 extends from a power adapter 46 and terminates in a male USB port 54. The male USB port 54 connects to one end of a standard female to female (“f2f”) USB adapter 56 coupled to the inner face 38 of the side rail 32 via a bracket 58. A cutout 42 in the side rail 32 corresponds to the opposite end of the f2f USB adapter 56, exposing that end of the USB adapter to the outer face 40 of the side rail. A male USB port connected to a portable electronic device can be inserted through the cutout 42 and connect to the f2f adapter 56, thereby connecting the electronic device to the power system of the powered utility side rail 30 and charging the electronic device.

In some embodiments, the powered utility rail includes at least one video connector. The video connector may be a VGA connector, DVI connector, coaxial connector, S-video connector, or other connector for connecting a video source to a display device. In some embodiments, the video connector is coupled to the at least one side rail, and is in communication via a data line with a video hub. The video hub is attached to the lower surface of the table top. The video hub includes an outside data line, which can be connected to a monitor, display, or other viewing device. In one embodiment, an individual may connect an electronic device to a VGA connector in the side rail and transmit visual data from the electronic device, through a VGA data line to a VGA hub, and on to a viewing device. In alternative embodiments, devices described as attached to the lower surface of the table top may be attached to the support frame or the side rail.

In some embodiments, the powered utility rail includes at least one data connector. The video connector may be a USB port, a micro-USB port, a serial computing port, a parallel computing port, a HDMI port, a FireWire port, an Ethernet port, or other connector for connecting a data source to a computing device. Note that USB ports and micro-USB ports provide both data and power connectivity, so these ports are considered both power outlets and data connectors.

In some embodiments, the data connector is coupled to the at least one side rail, and is in communication via a data line with a data hub. The data hub is attached to the lower surface of the table top. The data hub includes an outside data line, which can be connected to a computing device. In one embodiment, an individual may connect an electronic device to a Ethernet port (the data connector) in the side rail and transmit electronic data from the electronic device, through an Ethernet cable (the data line) to a Ethernet switch (the data hub), and on to a computing device. In alternative embodiments, devices described as attached to the lower surface of the table top may be attached to the support frame or the side rail.

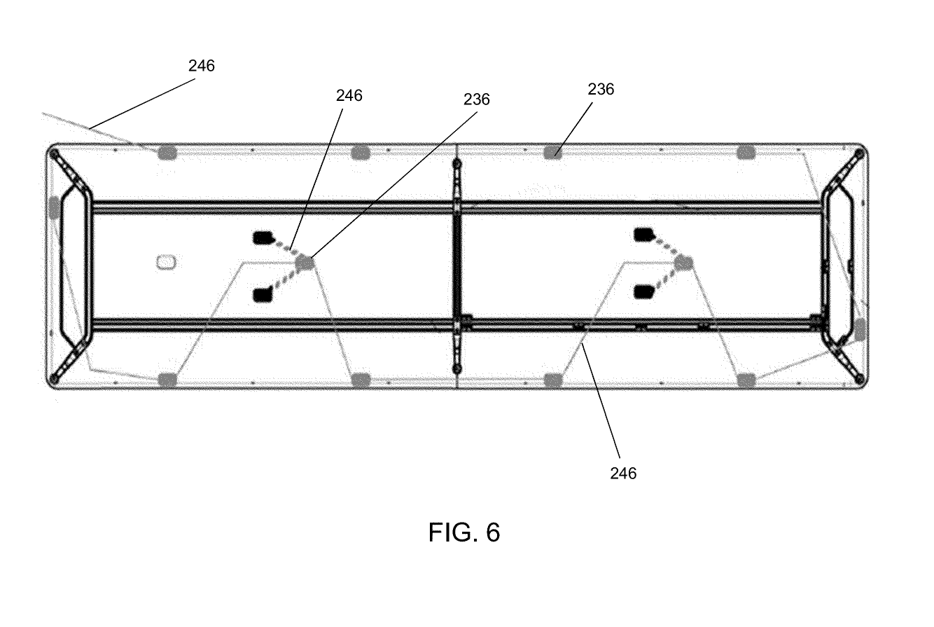

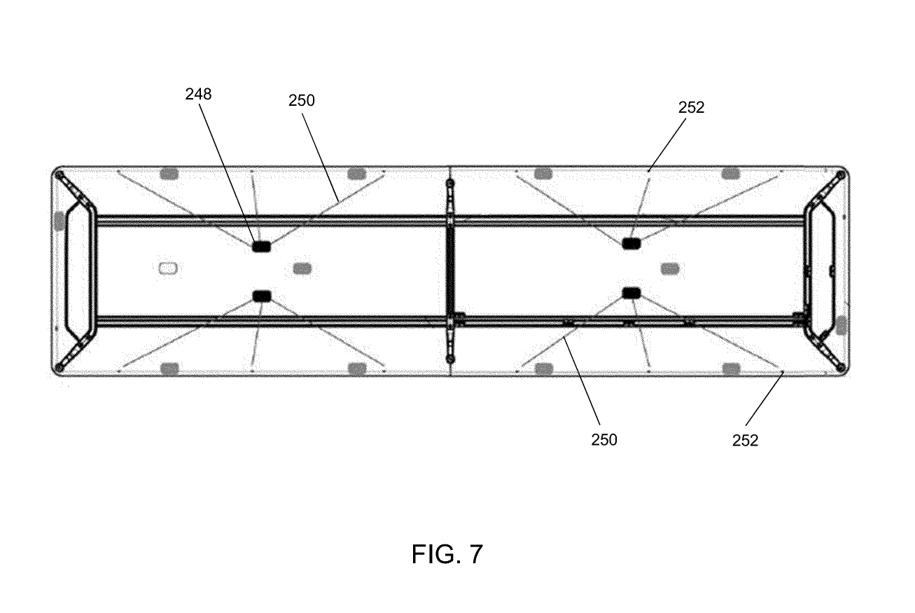

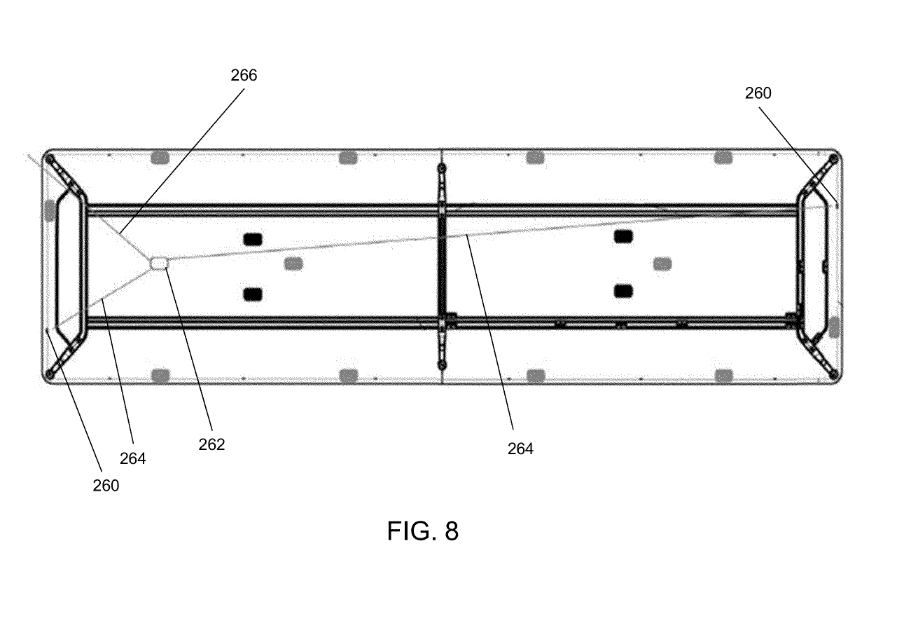

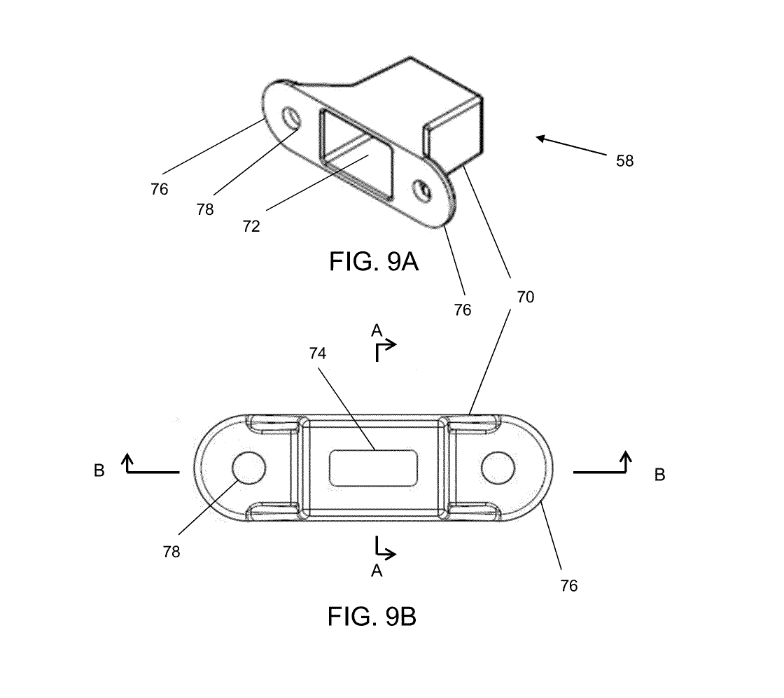

Referring now to FIGS. 5-8, an exemplary arrangement of components for a powered utility rail 230 installed on a table 210 is disclosed. In this embodiment, the table top 212 is rectangular in shape. The table is supported by a support frame 222. In this embodiment, the powered utility rail 230 includes a plurality of side rails 232, each side rail including at least one 110V power outlet 236 and at least one USB port 252. The powered utility rail also includes two 110V power outlets 236 attached to the supporting surface 218 a power conduit, four USB power adapters 248, and a low voltage power lines 250 connecting the power adapters 248 to the USB ports 252. The powered utility rail 230 also includes a pair of video connectors 60 connected to a video hub 62 via data lines 264, and an external data line 266 for connection to an external display device. The power adapters 248, the video hub 262, and the two power outlets 236 positioned near the center of the table top 212 are attached to the supporting surface 218. The low voltage power lines 250 and the power conduit 246 are attached to at least one of the supporting surface 218 and the side rails 232.

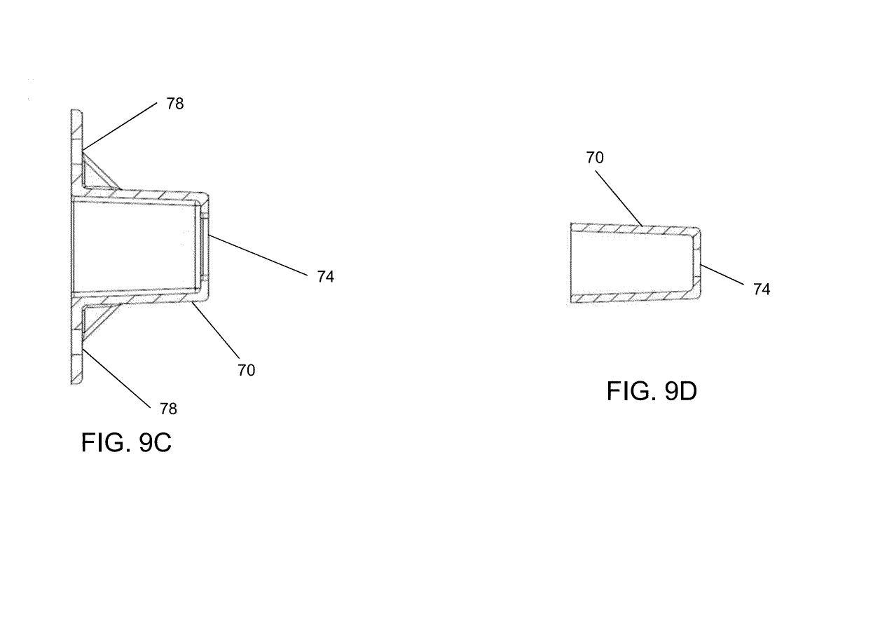

Referring now to FIGS. 9A-D, disclosed herein is an exemplary bracket 58 for coupling a USB port to a flat surface, in this case, the inner face of a side rail. A standard USB f2f adapter can be inserted within a bracket 58. The bracket includes a generally hollow body 70 defining a cavity sized to receive the f2f adapter. The body 70 includes an aperture 74 allowing the inserted end of the f2f adapter to extend through the bracket 58. The bracket 58 further includes a pair of opposing extensions 76, each having a bore 78. A side rail includes at a cutout sized to fit the end of the f2f adapter and a pair of threaded holes adjacent to the cutout. Screws extend through the bores 78 in the bracket 58 and into corresponding threaded holes, securing the bracket 58 to the side rail. As shown in FIG. 4, in the outer face 40 of the side rail 32, only the end of the f2f USB adapter is visible through the cutout 42. An individual may attach an electronic device with USB connectivity to the end of the f2f USB adapter 56, serving as a USB port 52, through the cutout 42. The opposing end of the f2f adapter inserted through the bracket aperture 74 is connected to a USB power adapter 48 via a low voltage power line 50. Electrical connectivity through this system allows the individual to charge an electronic device using the power utility rail 30.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1) A bracket for coupling a f2f USB adapter to a flat surface, the bracket comprising a hollow body defining a cavity sized to receive a standard f2f USB adapter having opposing ends, wherein the body includes an aperture allowing an inserted end of the f2f adapter to extend through the bracket, wherein the bracket includes a pair of opposing extensions extending substantially perpendicular to the body, each extension having a bore oriented substantially parallel to the body.

2) A powered utility rail comprising:
at least one side rail, the side rail including at least one power outlet and a fastener configured to secure the side rail beneath a supporting surface; and
a power conduit in electrical connection with the at least one power outlet.

3) The powered utility rail of claim 2, wherein the at least one side rail is at least one elongated side rail extending parallel to the supporting surface.

4) The powered utility rail of claim 2, wherein the supporting surface is a table top.

5) The powered utility rail of claim 2, wherein the supporting surface includes an opposing upper surface and at least one side connecting the upper surface and supporting surface.

6) The powered utility rail of claim 5, wherein the at least one side rail is spaced inwards from the at least one side and wherein the at least one side rail extends substantially parallel to the at least one side.

7) The powered utility rail of claim 5, wherein the supporting surface overhangs the at least one side rail.

8) The powered utility rail of claim 2, further comprising a plurality of side rails, each side rail including at least one power outlet and a fastener configured to secure the side rail beneath a supporting surface.

9) The powered utility rail of claim 8, further comprising a connector rail configured to couple two side rails.

10) The powered utility rail of claim 9, comprising four side rails and four connector rails forming a quadrilateral shape, wherein the side rails forming the sides of the quadrilateral shape and the connector rails forming the vertices of the quadrilateral shape.

11) The powered utility rail of claim 10, wherein the quadrilateral shape is one of a square and a rectangle.

12) The powered utility rail of claim 2, wherein the at least one side rail is formed in the shape of one of a circle and an oval.

13) The powered utility rail of claim 2, wherein the power conduit is in electrical connection with an external power source.

14) The powered utility rail of claim 2, wherein the at least one side rail includes at least one of a 110 volt power outlet, a 220 volt power outlet, a USB port, a micro-USB port, a serial computing port, a parallel computing port, a HDMI port, a FireWire port, an Ethernet port, a coaxial connector, a S-video connector, a VGA connector, and a DVI connector.

15) The powered utility rail of claim 2, wherein the at least one power outlet includes at least one of a USB port and a micro USB power outlet.

16) The powered utility rail of claim 15, further comprising a power adapter in electrical connection with the power conduit, and at least one low voltage power line in electrical connection with the power adapter and at least one of the at least one power outlet.

17) The powered utility rail of claim 2, wherein the at least one side rail includes at least one video connector.

18) The powered utility rail of claim 17, further comprising a video hub in communication with the at least one video connector via a data line.

19) The powered utility rail of claim 2, wherein the at least one side rail includes at least one data connector.

20) The powered utility rail of claim 19, further comprising a data hub in communication with the at least one data connector via a data line.
